(19) United States
(12) Patent Application Publication
(10) Pub. No.: US 2024/0258728 A1
(43) Pub. Date: Aug. 1, 2024

(54) LEAD ASSEMBLY, ELECTRICAL CONNECTOR, PRINTED CIRCUIT BOARD AND ELECTRONIC SYSTEM

(71) Applicant: Amphenol Commercial Products (Chengdu) Co., Ltd., Chengdu (CN)

(72) Inventor: Xiaodong Hu, Chengdu (CN)

(73) Assignee: Amphenol Commercial Products (Chengdu) Co., Ltd., Chengdu (CN)

(21) Appl. No.: 18/427,619

(22) Filed: Jan. 30, 2024

(30) Foreign Application Priority Data
Jan. 31, 2023 (CN) 202320163446.0

(51) Int. Cl. H01R 12/73; H01R 12/72

(52) U.S. Cl. CPC H01R 12/737; H01R 12/722

(57) ABSTRACT

A connector for use with high-speed signals. The connector has conductive elements aligned in a longitudinal direction. Each conductive element comprises a mating contact portion, a mounting tail opposite the mating contact portion, and an intermediate portion joining the mating contact portion and the mounting tail. The mounting tail comprises a connecting portion extending from the intermediate portion, a mounting end opposite the connecting portion, and a main portion joining the connecting portion and the mounting end. The mounting end has a diminishing longitudinal width in a mounting direction. The main portion has a longitudinal width narrower than the connecting portion. The connecting portions of adjacent conductive elements extend toward opposite direction such that the corresponding mounting tails are offset from each other. Such a configuration enables the mounting tails to be inserted into through-holes in the printed circuit board with high error tolerance.

### CROSS-REFERENCE TO RELATED APPLICATIONS

This application claims priority to and the benefit of Chinese Patent Application Serial No. 202320163446.0, filed on Jan. 31, 2023. The contents of this application are incorporated herein by reference in their entirety.

### TECHNICAL FIELD

The present disclosure relates generally to the technical field of connectors, and in particular, to a lead assembly, an electrical connector, a printed circuit board and an electronic system.

### BACKGROUND

Electrical connectors are used in many electronic systems. It is generally easier and more cost effective to manufacture a system as several printed circuit boards which may be joined together with electrical connectors than to manufacture the system as a single assembly. A traditional arrangement for interconnecting several printed circuit boards is usually to have one printed circuit board as a backplane. Then, other circuit boards called daughter boards or daughter cards are connected to the backplane by electrical connectors to interconnect these circuit boards.

The Joint Electron Device Engineering Council (JEDEC) provides an electrical connector using surface mount technology (SMT). The electrical connector has good signal integrity (SI) in transmitting signals which can meet requirements in use, but has poor market competitiveness in costs.

### BRIEF SUMMARY

Aspects of the present disclosure relate to lead assembly, electrical connector, printed circuit board and electronic system.

Some embodiments relate to a lead assembly. The lead assembly may include a plurality of conductive elements arranged along a longitudinal direction, each of the plurality of conductive elements comprising a mating contact portion, a mounting tail opposite the mating contact portion, and an intermediate portion joining the mating contact portion and the mounting tail, the mounting tail comprising: a connecting portion extending from the intermediate portion, a mounting end opposite the connecting portion, and a main portion joining the connecting portion and the mounting end, wherein: the mounting end has a diminishing longitudinal width in a mounting direction, and the main portion is narrower than the connecting portion in the longitudinal direction.

Optionally, the main portion comprises a first subportion extending from the connecting portion and a second mounting subportion extending from the mounting end; and the first subportion is wider than the second subportion portion in the longitudinal direction.

Optionally, the main portion comprises a transition subportion joining the first subportion and the second subportion; and the transition subportion tapers from the first subportion to the second subportion in the longitudinal direction.

Optionally, the first subportion is longer than the second subportion in a vertical direction perpendicular to the longitudinal direction.

Optionally, the first subportion is at least twice as long as the second subportion.

Optionally, the second subportion has a longitudinal width between 0.17 mm and 0.23 mm.

Optionally, the first subportion has a longitudinal width between 0.22 mm to 0.28 mm.

Optionally, the mounting end has a length between 0.15 mm and 0.25 mm in a vertical direction perpendicular to the longitudinal direction.

Optionally, a tapered tip of the mounting end has a longitudinal width between 0.05 mm and 0.15 mm.

Optionally, the plurality of conductive elements comprise a plurality of first-type conductive elements and a plurality of second-type conductive elements alternately arranged along the longitudinal direction; and the mounting end of the mounting tail of each of the plurality of second-type conductive elements is disposed farther from the mounting end of the mounting tail of a first adjacent first-type conductive element than the mounting end of the mounting tail of a second adjacent first-type conductive elements.

Optionally, the connecting portion of the mounting tail of each of the plurality of first-type conductive elements extends from a first side of the intermediate portion of a respective conductive element; the connecting portion of the mounting tail of each of the plurality of second-type conductive elements extends from a second side of the intermediate portion of a respective conductive element; and for the intermediate portion of each of the plurality of conductive elements, the first side and the second side are opposite in the longitudinal direction.

Optionally, the connecting portion of each of the plurality of first-type conductive elements is bent, with respect to a respective intermediate portion, in a first transverse direction perpendicular to the longitudinal direction; and the connecting portion of each of the plurality of second-type conductive elements is bent, with respect to a respective intermediate portion, in a second transverse direction opposite to the first transverse direction.

Some embodiments relate to an electrical connector. The electrical connector may include a housing comprising a mating surface having a slot extending in a longitudinal direction and a mounting surface opposite the mating surface; a plurality of first-type conductive elements aligned in the longitudinal direction, each of the plurality of first-type conductive elements comprising a mating contact portion curving into the card slot and a mounting tail opposite the mating contact portion and extending beyond the mounting surface, the mounting tail having a mounting end; and a plurality of second-type conductive elements, each of the plurality of second-type conductive elements comprising a mating contact portion curving into the card slot and a mounting tail opposite the mating contact portion and extending beyond the mounting surface, the mounting tail having a mounting end, wherein: each of the plurality of second-type conductive elements is disposed between respective first and second adjacent first-type conductive elements; and the mounting end of the mounting tail of each of the plurality of second-type conductive elements is disposed farther from the mounting end of the mounting tail of the respective first adjacent first-type conductive element than the mounting end of the mounting tail of the respective second adjacent first-type conductive element.

Optionally, each of the plurality of first-type conductive elements comprises an intermediate portion joining the mating contact portion and the mounting tail; and for each of the plurality of first-type conductive elements: the mounting tail comprises a connection portion extending from the intermediate portion and a main portion joining the connecting portion and the mounting end, and the main portion is narrower than the connecting portion in the longitudinal direction.

Optionally, each of the plurality of second-type conductive elements comprises an intermediate portion joining the mating contact portion and the mounting tail; and for each of the plurality of second-type conductive elements: the mounting tail comprises a connection portion extending from the intermediate portion and a main portion joining the connecting portion and the mounting end, and the main portion is narrower than the connecting portion.

Optionally, the main portion comprises a first subportion extending from the connecting portion and a second mounting subportion extending from the mounting end; and the first subportion is wider than the second subportion in the longitudinal direction.

Optionally, the first subportion is longer than the second subportion in a vertical direction perpendicular to the longitudinal direction.

Some embodiments relate to an electronic system. The electronic system may include a printed circuit board comprising a plurality of pads and a plurality of through-holes, each of the plurality of through-holes passing through a respective pad of the plurality of pads and sized in the range of 0.35 mm to 0.45 mm; and an electrical connector mounted on the printed circuit board, the electrical connector comprising: a housing comprising a mating surface having a slot and a mounting surface opposite the mounting surface, and a plurality of conductive elements, each of the plurality of conductive elements comprising a mating contact portion curving into the slot, a mounting tail extending beyond the mounting surface into a respective through-hole of the plurality of through-holes, the plurality of conductive elements configured to transfer data signals at rates in the range of 10 Gb/s to 150 Gb/s.

Optionally, the plurality of conductive elements comprise a plurality of first-type conductive elements and a plurality of second-type conductive elements disposed alternatively; and the mounting end of the mounting tail of each of the plurality of second-type conductive elements is disposed farther from the mounting end of the mounting tail of a first adjacent first-type conductive element than the mounting end of the mounting tail of a second adjacent first-type conductive element.

Optionally, the plurality of through-holes comprise a plurality of first through-holes and a plurality of second through-holes; and each of the plurality of second through-holes is disposed farther from a first adjacent first through-hole than a second adjacent first through-hole such that the plurality of first through-holes receive the plurality of first-type conductive elements and the plurality of second through-holes receive the plurality of second-type conductive elements.

Some embodiments relate to a lead assembly. The lead assembly may comprise a plurality of conductive elements arranged along a longitudinal direction. Each of the plurality of conductive elements may comprise a mating contact portion, a through-hole mounting tail and an intermediate portion. The through-hole mounting tail may be opposite to the mating contact portion. The intermediate portion may be connected between the mating contact portion and the through-hole mounting tail. The through-hole mounting tail may comprise an intermediate portion connecting portion, an mounting end, and an mounting main portion. The intermediate portion connecting portion may be connected to the intermediate portion. The mounting end may be opposite to the intermediate portion connecting portion. The mounting main portion may be connected between the intermediate portion connecting portion and the mounting end. The mounting end may have a diminishing longitudinal width in a mounting direction. The longitudinal width of the mounting main portion may be less than the longitudinal width of the intermediate portion connecting portion.

Optionally, the mounting main portion may comprise a first mounting subportion and a second mounting subportion. The first mounting subportion may be connected to the intermediate portion connecting portion. The second mounting subportion may be connected to the mounting end. The longitudinal width of the first mounting subportion may be greater than the longitudinal width of the second mounting subportion.

Optionally, a transition subportion may be connected between the first mounting subportion and the second mounting subportion. The transition subportion tapers from the first mounting subportion to the second mounting subportion along the longitudinal direction.

Optionally, the length of the first mounting subportion may be greater than the length of the second mounting subportion.

Optionally, the length of the first mounting subportion may be greater than twice the length of the second mounting subportion.

Optionally, the longitudinal width of the second mounting subportion may be between 0.17 mm and 0.23 mm.

Optionally, the longitudinal width of the first mounting subportion may be between 0.22 mm to 0.28 mm.

Optionally, the length of the mounting end may be between 0.15 mm and 0.25 mm.

Optionally, the longitudinal width of the tip of the mounting end may be between 0.05 mm and 0.15 mm.

Optionally, the plurality of conductive elements may comprise a plurality of first-type conductive elements and a plurality of second-type conductive elements. The plurality of first-type conductive elements and the plurality of second-type conductive elements may be alternately arranged along the longitudinal direction. The mounting end of the through-hole mounting tail of each of the plurality of second-type conductive elements may have a greater distance to an mounting end of a through-hole mounting tail of a first adjacent first-type conductive element than to an mounting end of a through-hole mounting tail of a second adjacent first-type conductive element.

Optionally, the intermediate portion connecting portion of the through-hole mounting tail of each of the plurality of first-type conductive elements may be connected to the first side of its respective intermediate portion. The intermediate portion connecting portion of the through-hole mounting tail of each of the plurality of second-type conductive elements may be connected to the second side of its respective intermediate portion. The first side and the second side may be opposite along the longitudinal direction.

Optionally, the intermediate portion connecting portion of each of the plurality of first-type conductive elements may be bent in the first transverse direction with respect to its respective intermediate portion. The intermediate portion connecting portion of each of the plurality of second-type conductive elements may be bent in the second transverse direction with respect to its respective intermediate portion. The first transverse direction and the second transverse direction may be opposite and both perpendicular to the longitudinal direction.

Some embodiments relate to an electrical connector. The electrical connector may comprise an insulating housing and a lead assembly as described above. The insulating housing may have an interfacing surface and a mounting surface. The interfacing surface and the mounting surface may be opposed to each other. The interfacing surface is provided with a card slot extending in longitudinal direction. The lead assembly may be mounted in the insulating housing. The mating contact portions of the plurality of conductive elements bent into the card slot. The mounting main portions and the mounting ends of the through-hole mounting tails of the plurality of conductive elements may extend beyond the mounting surface.

Some embodiments relate to an electrical connector. The electrical connector may comprise an insulating housing and a plurality of conductive elements. The insulating housing may have an interfacing surface and a mounting surface. The interfacing surface and the mounting surface may be opposed to each other. The interfacing surface is provided with a card slot extending in longitudinal direction. Each of the plurality of conductive elements may comprise a mating contact portion, a through-hole mounting tail, and an intermediate portion. The mating contact portion may be bent into the card slot. The through-hole mounting tail may be opposite to the mating contact portion. The intermediate portion may be connected between the mating contact portion and the through-hole mounting tail. The through-hole mounting tail may extend beyond the mounting surface. The plurality of conductive elements are configured to transfer data signals at rates up to 150 Gb/s.

Optionally, the plurality of conductive elements may comprise a plurality of first-type conductive elements and a plurality of second-type conductive elements. The plurality of first-type conductive elements and the plurality of second-type conductive elements may be alternately arranged along the longitudinal direction. The mounting end of the through-hole mounting tail of each of the plurality of second-type conductive elements may have a greater distance to an mounting end of a through-hole mounting tail of a first adjacent first-type conductive element than to an mounting end of a through-hole mounting tail of a second adjacent first-type conductive elements.

Some embodiments relate to a printed circuit board. The printed circuit board may have a footprint. The footprint may be provided with a plurality of pads and a plurality of through-holes. Each of the plurality of through-holes may pass through a corresponding pad. The apertures of the through-holes may be between 0.35 mm-0.45 mm.

Optionally, the plurality of through-holes may comprise a plurality of first through-holes and a plurality of second through-holes. The plurality of first through-holes and the plurality of second through-holes may be alternately arranged along the longitudinal direction. Each of the plurality of second through-holes may have a greater distance to a first adjacent first through-hole than to a second adjacent first through-hole.

Optionally, each of the plurality of second through-holes may form a group with its first adjacent first through-hole. As for two adjacent groups, a first through-hole and a second through-hole in one group may be located on their respective anti-pads. A first through-hole and a second through-hole in the other group may be not provided with any anti-pad. The groups with anti-pads may be alternately disposed with the groups without any anti-pad along the longitudinal direction.

Optionally, the printed circuit board may be provided with conductive traces. The gaps between the conductive traces and the anti-pads may be greater than or equal to 0.08 mm. Optionally, the gaps between adjacent conductive traces may be greater than or equal to 0.08 mm.

Optionally, shadow ground vias may be provided between the second through-holes and their second adjacent first through-hole.

Optionally, Each of the plurality of second through-holes may have a greater distance to the first adjacent first through-hole than to the second adjacent first through-hole along longitudinal direction.

Optionally, a reference line is provided extending along the longitudinal direction. The centers of the plurality of first through-holes and the centers of the plurality of second through-holes may be separately located on two sides of the reference line.

Some embodiments relate to an electronic system is provided. The electronic system may comprise an electrical connector as described and a printed circuit board as described. The through-hole mounting tails of the plurality of conductive elements of the electrical connector may be correspondingly inserted into the plurality of through-holes and soldered to the respective pads.

These techniques may be used alone or in any suitable combination. The foregoing summary is provided by way of illustration and is not intended to be limiting.

### BRIEF DESCRIPTION OF DRAWINGS

The accompanying drawings may not be drawn to scale. In the drawings, each identical or nearly identical component that is illustrated in various figures may be represented by a like numeral. For purposes of clarity, not every component may be labeled in every drawing. In the drawings:

FIG. 1 is a perspective view of an electronic system according to an exemplary embodiment of the present disclosure from one perspective;

FIG. 2 is a perspective view of the electronic system as shown in FIG. 1 from another perspective;

FIG. 3A is a perspective view of a printed circuit board according to an exemplary embodiment of the present disclosure;

FIG. 3B is a partially enlarged view of the printed circuit board as shown in FIG. 3A;

FIG. 4 is a perspective view of an electrical connector according to an exemplary embodiment of the present disclosure from one perspective;

FIG. 5 is a perspective view of the electrical connector as shown in FIG. 4 from another perspective;

FIG. 6 is a partially enlarged view of the electrical connector as shown in FIG. 5;

FIG. 7 is a perspective view of a lead assembly according to an exemplary embodiment of the present disclosure from one perspective;

FIG. 8 is a perspective view of the lead assembly as shown in FIG. 7 from another perspective;

FIG. 9A is a front view of the lead assembly as shown in FIG. 7;

FIG. 9B is a partially enlarged view of FIG. 9A;

FIG. 10 is a side view of the lead assembly as shown in FIG. 7;

FIG. 11 is a bottom view of a portion of the lead assembly as shown in FIG. 7;

FIG. 12 is a perspective view of a first-type conductive element according to an exemplary embodiment of the present disclosure;

FIG. 13 is a perspective view of a second-type conductive element according to an exemplary embodiment of the present disclosure;

FIG. 14 is a partial perspective view of an insulating housing according to an exemplary embodiment of the present disclosure; and

FIG. 15 is a schematic partial view of a routing layer of a footprint of a printed circuit board according to an exemplary embodiment of the present disclosure.

The above accompanying drawings include the following reference signs:

100, electrical connector; 200, insulating housing; 201, interfacing surface; 202, mounting surface; 210, card slot; 212, separating rib; 220, first mounting cavity; 221, first portion; 222, second portion; 230, second mounting cavity; 231, third portion; 232, fourth portion; 300, lead assembly; 301, conductive element; 310, mating contact portion; 320, through-hole mounting tail; 330, intermediate portion; 340, intermediate portion connecting portion; 350, mounting main portion; 351, first mounting subportion; 352, second mounting subportion; 353. transition subportion; 360, mounting end; 400, first-type conductive element; 401, first adjacent first-type conductive element; 402, second adjacent second-type conductive element; 420, through-hole mounting tail of first-type conductive element; 421, through-hole mounting tail of first adjacent first-type conductive element; 422, through-hole mounting tail of second adjacent first-type conductive element; 500, second-type conductive element; 520, through-hole mounting tail of second-type conductive element; 600, latch; 700, add-in card; 800, printed circuit board; 810, footprint; 820, first through-hole; 821, first adjacent first through-hole; 822, second adjacent first through-hole; 830, second through-hole; 840a, 840b, 840c, group; 850, anti-pad; 860, conductive trace.

### DETAILED DESCRIPTION

Electronic systems generally have gotten smaller, faster, and functionally more complex. Because of these changes, the number of circuits in a given area of an electronic system, along with the frequencies at which the circuits operate, have increased significantly in recent years. Current systems pass more data between printed circuit boards and require electrical connectors that are electrically capable of handling more data at higher speeds than connectors of even a few years ago. Internet servers and routers are examples of data processing systems that can support multiple high-speed data channels. Data rates per channel in such a system can be as high as or far higher than 10 gigabits per second (Gb/s). In some embodiments, for example, the data rates may be as high as 150 Gb/s. In some embodiments, as described herein, an electrical connector can be used to transmit data over such high-speed data channels.

An electrical connector may be configured to carry signals according to a DDR (Double Data Rate) standard. For existing DDR4 (Double Data Rate Fourth-Generation) connectors, JEDEC provides specifications for surface mount technology and through hole technology (THT). Under the JEDEC specifications, there are two types of DDR4 electrical connectors. The conductive elements of one type of DDR4 electrical connectors are connected to the motherboard by surface mount technology, and the conductive elements of the other type of DDR4 electrical connectors are connected to the motherboard by through hole technology. The inventors have recognized and appreciated that JEDEC only provides a specification for DDR5 (Double Data Rate Fifth-Generation) surface mount design, since existing electrical connectors with through hole technology cannot meet the SI performance requirements of DDR5. The inventors have recognized and appreciated that DDR5 electrical connector using surface mount technology has higher manufacturing cost, which may lead to poor market competitiveness of the DDR5 electrical connector.

The inventors have recognized and appreciated connector design techniques that enable connectors with through hole technology to meet the SI performance of DDR5. The connector design techniques may improve signal transmission quality and reduced crosstalk, resulting in better SI performance. In some embodiments, an electrical connector may include a plurality of first-type conductive elements and a plurality of second-type conductive elements arranged alternately. Each second-type conductive element has a first adjacent first-type conductive element located on one side and a second adjacent first-type conductive element located on its other side. The distance from the through-hole mounting tail of the second-type conductive element to the through-hole mounting tail of the first-type conductive element is greater than the distance to the through-hole mounting tail of the second adjacent first-type conductive element. In this way, the distance between the through-hole mounting tails of some conductive elements (e.g., two conductive elements within a differential signal pair) can be closer, and the distance between the through-hole mounting tails of some other conductive elements (e.g., two conductive elements between adjacent differential signal pairs) can be greater, such that a greater distance can be formed between conductive elements which are more likely to cause degradation of SI performance. This distance can also provide more routing space for conductive traces of the printed circuit board.

In some embodiments, the through-hole mounting tails of the first-type conductive elements may be offset in a first longitudinal direction, so that the distances between the through-hole mounting tails of two first-type conductive elements adjacent to a second-type conductive element to the through-hole mounting tail of the second-type conductive element are unequal. In order to further increase the difference of the distance between the through-hole mounting tail of the first adjacent first-type conductive element and the through-hole mounting tail of the second-type conductive element with the distance between the through-hole mounting tail of the second adjacent first-type conductive element and the through-hole mounting tail of the second-type conductive element, the through-hole mounting tail of the second-type conductive element can also be offset towards a second longitudinal direction. The inventors have also recognized and appreciated that when the through-hole mounting tail of the second-type conductive element is too close to the through-hole mounting tail of the second adjacent first-type conductive element, their through-holes (Plating Through Holes) in the printed circuit board may be too close. The apertures of the through-holes are usually larger than the sizes of the through-hole mounting tails, and the through-holes also have to pass through the pads formed on the surface of the printed circuit board.

The inventors have recognized and appreciated that making the through-hole mounting tails of the first-type conductive elements and the through-hole mounting tails of the second-type conductive elements to offset in the opposite directions along the transverse direction can increase a distance between the through-hole mounting tail of the second-type conductive element and the through-hole mounting tail of the second adjacent first-type conductive element. In such arrangement, the routing space between the through-hole mounting tails of the first adjacent first-type conductive elements and the through-hole mounting tails of the second-type conductive elements can have a width up to 0.72 mm, while the routing space of DDR4 electrical connectors has a width of only 0.19 mm.

The inventors have recognized and appreciated techniques that provide a mechanically robust connector, even when miniaturized and configured to pass numerous signals. With these techniques, the sizes of the mounting cavities of the insulating housing for mounting conductive elements in the surface mount electrical connector are not too large. The mounting cavities with excessive sizes will result in thinner thicknesses of the insulating housing. During reflow soldering, the portions with thinner thicknesses are prone to warping. Warping can cause that the conductive elements are unstably fixed in the mounting cavity, the add-in card is unfirmly inserted in the card slot of the insulating housing, or the latches unreliably lock the add-in card to the insulating housing because of deformed towers of the insulating housing. Any of the reasons above can lead to malfunction of the electrical connectors. In the embodiments provided in the present disclosure, the mounting cavities could be slightly larger. Since through-hole mounting tails of conductive elements have various types of offset, including torsion and/or bending, it also happens to require mounting cavities large enough to ensure that the portions of the through-hole mounting tails protruding beyond the insulating housing are straight. As a result, the benefits can be manifold.

The inventors has recognized and appreciated that various techniques may be used alone or in any suitable combination to improve the signal integrity of the electrical connector. Although the techniques are described in connection with a card edge connector, the techniques described herein may be used in connection with other types of electrical connectors.

The electronic system of some embodiments are described below in detail in conjunction with the accompanying drawings. For clarity and conciseness of the description, the vertical direction Z-Z, the longitudinal direction X1-X2, and the transverse direction Y1-Y2 are defined. The vertical direction Z-Z, the longitudinal direction X1-X2, and the transverse direction Y1-Y2 can be perpendicular to each other. Vertical direction Z-Z usually refers to the height direction of the electrical connector. Longitudinal direction X1-X2 usually refers to the length direction of the electrical connector. The transverse direction Y1-Y2 usually refers to the width direction of the electrical connector.

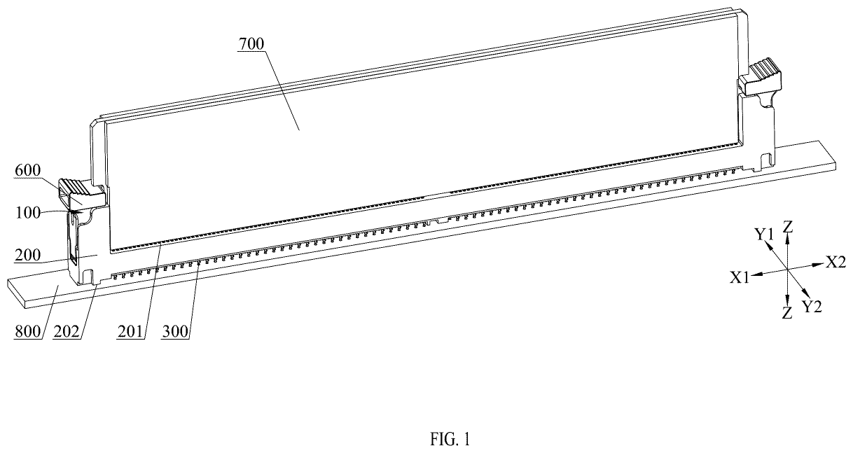

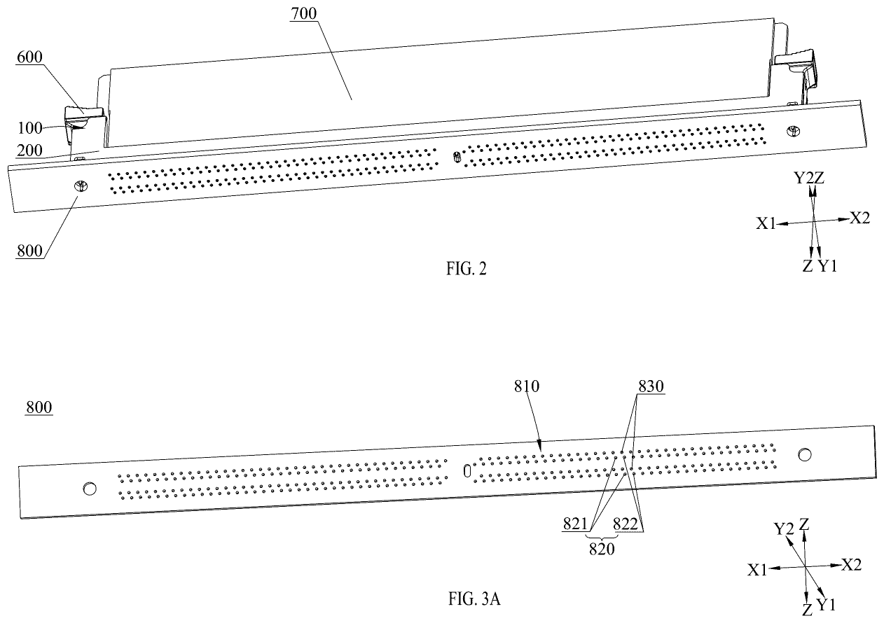

FIGS. 1-2 shows an electronic system according to an embodiment of the present disclosure. The electronic system may include an electrical connector 100 and a printed circuit board 800. The electrical connector 100 may be a card edge connector, such as DDR5 electrical connector. As illustrated, the electrical connector 100 has an add-in card 700 inserted therein. The add-in card 700 can be electrically connected to the printed circuit board 800 through the electrical connector 100. The electrical connector 100 is widely used to interconnect the printed circuit board and the add-in card in the electronic systems. The add-in card includes, is but not limited to, a graphics card or a memory card. The electrical connector 100 using through hole technology is connected to the printed circuit board 800.

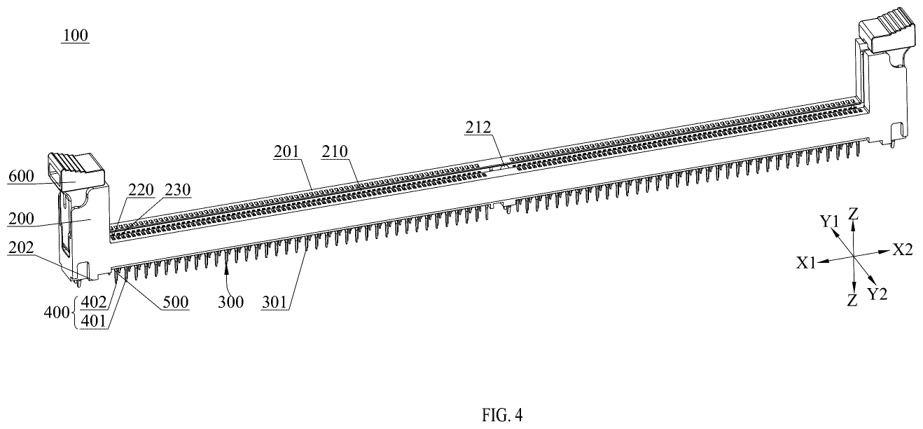

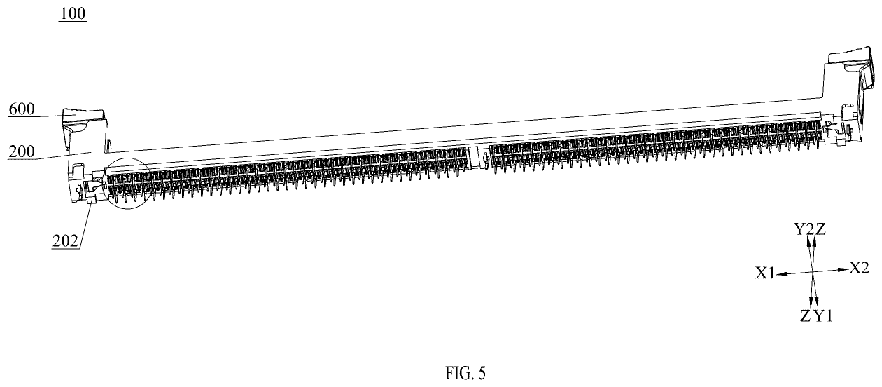

FIGS. 4-5 shows an electrical connector 100 according to an embodiment of the present disclosure, the electrical connector 100 may include an insulating housing 200 and a lead assembly 300.

The insulating housing 200 may be molded from an insulating material such as plastic. The plastic may include but is not limited to, liquid crystal polymer (LCP), polyphenylene sulfur (PPS), high-temperature nylon or polyterephenyl oxide (PPO) or polypropylene (PP), or any other suitable materials. In some cases, the plastic may be thermoset. In some cases, the plastic may include reinforced insulating material, such as glass fiber. The insulating housing 200 can be a single piece. The insulating housing 200 may have an interfacing surface 201 and a mounting surface 202. The interfacing surface 201 may be provided with a card slot 210 extending along the longitudinal direction X1-X2. The card slot 210 may be recessed towards the mounting surface 202, thereby receiving the edge of the add-in card 700. The edge of the add-in card 700 can be inserted into the card slot 210. The electrical connector 100 shown in the figures is a vertical connector, the interfacing surface 201 and the mounting surface 202 may be opposed to each other in the vertical direction Z-Z. In other embodiments not shown, the card edge connector may also be configured as an orthogonal connector, where the interfacing surface and the mounting surface may be perpendicular to each other. In that condition, and still with the extension direction of the card slot in the interfacing surface as the longitudinal direction X1-X2, the mounting surface may be perpendicular to the longitudinal direction X1-X2. However, regardless of the type of electrical connector 100, the interfacing surface 201 and the mounting surface 202 in various electrical connectors roughly take the same role. The interfacing surface 201 is used for connection with the add-in card 700, and the mounting surface 202 is used for connection with the printed circuit board 800.

Exemplarily, as shown in FIGS. 1-2 and 4-5, the electrical connector 100 may include latches 600. The latches 600 may be pivotably connected to the insulating housing 200 between a locking position and an unlocking position. The latches 600 can be arranged in pairs. The latches 600 in pairs may be connected to both ends of the insulating housing 200. The latches 600 may be molded from an insulation material such as plastic. The latches 600 each is typically a single piece. The latches 600 can be made of the same material as the insulating housing 200. Alternatively or additionally, the latches 600 can be made of a different material with the insulating housing 200. In some cases, the latches 600 may be provided with metal reinforcement members. The latches 600 can be used to lock the add-in card 700 to the electrical connector 100 when in the locking position.

As shown in FIGS. 4-5, the insulating housing 200 may be provided with one or more sets of lead assemblies 300. The lead assemblies 300 may be mounted to the insulating housing 200. When a plurality of sets of lead assemblies 300 are provided, these lead assemblies 300 may be arranged in two rows on both sides of the card slot 210 opposed along the transverse direction Y1-Y2, each row extends along the longitudinal direction X1-X2. Optionally, two rows of lead assemblies 300 may be aligned with each other along the longitudinal direction X1-X2. Optionally, the two rows of lead assemblies 300 may be staggered along the longitudinal direction X1-X2 to increase the gaps between the lead assemblies 300 to reduce crosstalk. Alternatively or additionally, the lead assemblies 300 may be located on one side of the card slot 210. In the insulating housing 200 provided with a separating rib 212 in the card slot 210, there may be two sets of lead assemblies 300 on any one side of the card slot 210, and the two sets of lead assemblies 300 are located on both sides of the separation rib 212.

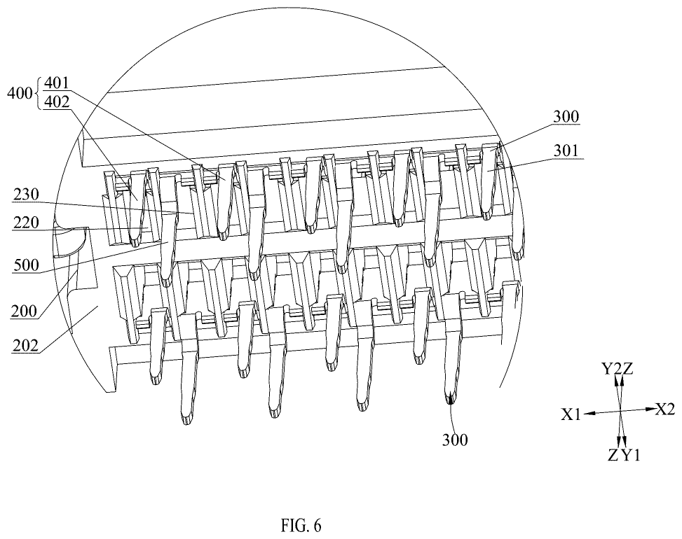

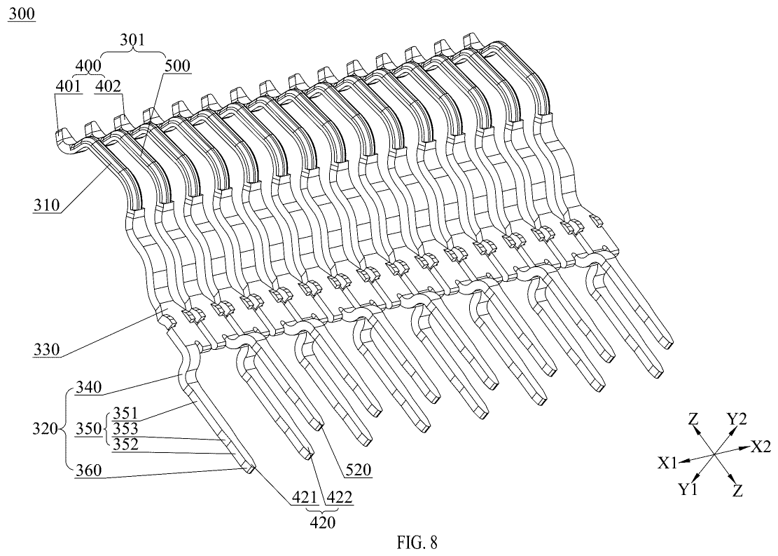

Each set of lead assemblies 300 may include a plurality of conductive elements 301. The plurality of conductive elements 301 may be arranged along the longitudinal direction X1-X2. The conductive element 301 may be made of a conductive material such as a metal. The conductive elements 301 each is typically an elongated single piece. One end of each of the conductive elements 301 extends into the card slot 210 and the other end extends beyond the mounting surface 202. Specifically, as shown in FIGS. 6-9A, each conductive element 301 may include a mating contact portion 310, an intermediate portion 330 and a through-hole mounting tail 320 along its extension direction. The mating contact portion 310 and the through-hole mounting tail 320 may be opposed to each other along the extension direction of the conductive element 301. The intermediate portion 330 may join the mating contact portion 310 and the through-hole mounting tail 320.

The mating contact portion 310 may be bent into the card slot 210. Typically, the mating contact portion 310 is usually curved towards the card slot 210 and protrudes into the card slot 210. The through-hole mounting tail 320 may extend beyond the mounting surface 202. The through-hole mounting tail 320 may be connected to the printed circuit board 800 by the through hole technology. In practical applications, after the edge of the add-in card 700 is inserted into the card slot 210, the golden fingers of the add-in card 700 may be in contact with the mating contact portions 310 of the electrical connector, thereby achieving an electrical connection with the electrical connector. The through-hole mounting tails 320 of the electrical connector may be inserted into through-holes in the printed circuit board 800, and soldered to the pads on the printed circuit board 800, thereby achieving an electrical connection with the printed circuit board 800. Thus, the electrical connector 100 may interconnect the add-in card 700 and the circuits of the printed circuit board 800.

The through-hole mounting tails 320 each may include an intermediate portion connecting portion 340, a mounting main portion 350 and a mounting end 360 along the extension direction of the conductive element 301. The intermediate portion connecting portion 340 may be connected to the intermediate portion 330. The intermediate portion connecting portion 340 may be curved. The intermediate portion 330 and the intermediate portion connecting portion 340 may be configured to be accommodated within the insulating housing 200 of the electrical connector 100. The intermediate portion connecting portion 340 and the mounting end 360 may be opposed to each other along the extension direction of the conductive element 301. The mounting main portion 350 may be connected between the intermediate portion connecting portion 340 and the mounting end 360. The mounting main portion 350 may extend along the vertical direction Z-Z for easy insertion into the through-hole in the printed circuit board 800. The mounting end 360 may have a diminishing longitudinal width in the insertion direction of the add-in card 700 inserted into the card slot 210. The longitudinal width of the mounting main portion 350 may be less than the longitudinal width of the intermediate portion connecting portion 340.

Thus, in the process of inserting the edge of the add-in card 700 into the card slot 210 along the insertion direction, the through-hole mounting tails 320 of the lead assembly 300 provided by the embodiments of the present disclosure may be inserted into the through-holes in the printed circuit board 800 smoothly, since the mounting ends 360 have a diminishing longitudinal width in the insertion direction, and the longitudinal width of the mounting main portions 350 are less than the longitudinal width of the intermediate portion connecting portions 340. Therefore, the conductive elements 301 are guided appropriately in the installation, which can improve the installation efficiency.

Exemplarily, the mounting ends 360 and the mounting main portions 350 of the through-hole mounting tails 320 may extend beyond the mounting surface 202. In this way, the mounting ends 360 and the mounting main portions 350 could be inserted into the through-holes in the printed circuit board 800.

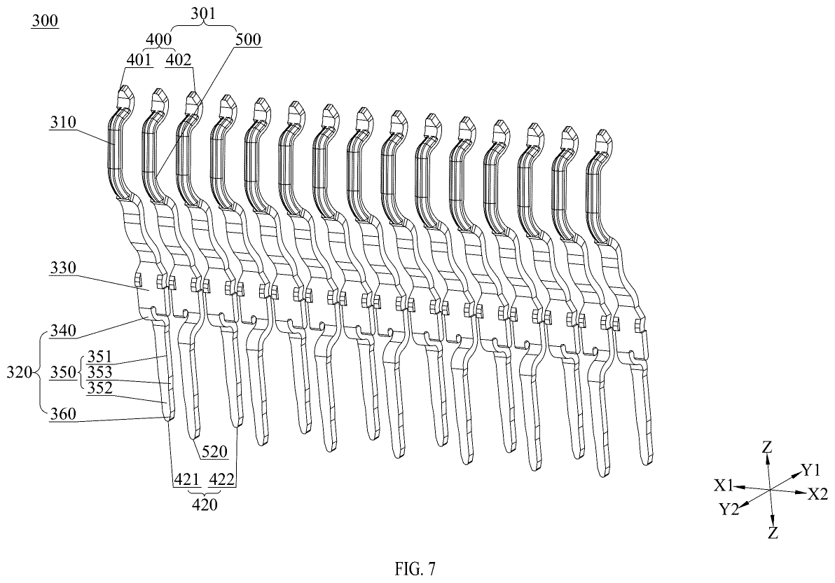

As shown in FIGS. 7-9A, the mounting main portions 350 each may include a first mounting subportion 351 and a second mounting subportion 352. The first mounting subportion 351 may be connected to the intermediate portion connecting portion 340. The second mounting subportion 352 may be connected to the mounting end 360. The first mounting subportion 351 and the second mounting subportion 352 are directly or indirectly connected to each other. The longitudinal width of the first mounting subportion 351 may be greater than the longitudinal width of the second mounting subportion 352. In this way, the mounting main portion 350 has a diminishing longitudinal width in the inserting direction for a smooth insertion of the through-hole mounting tail 320 into the through-hole in the printed circuit board 800.

Exemplary, as shown in FIGS. 7-9B, the mounting main portion 350 may further include a transition subportion 353. The transition subportion 353 may be connected between the first mounting subportion 351 and the second mounting subportion 352. The transition subportion 353 tapers from the first mounting subportion 351 to the second mounting subportion 352. In this way, the mounting main portion 350 has a diminishing longitudinal width in the inserting direction so as to ensure a more smooth insertion into the through-hole in the printed circuit board 800. Moreover, it is convenient for the conductive element 301 to be manufactured.

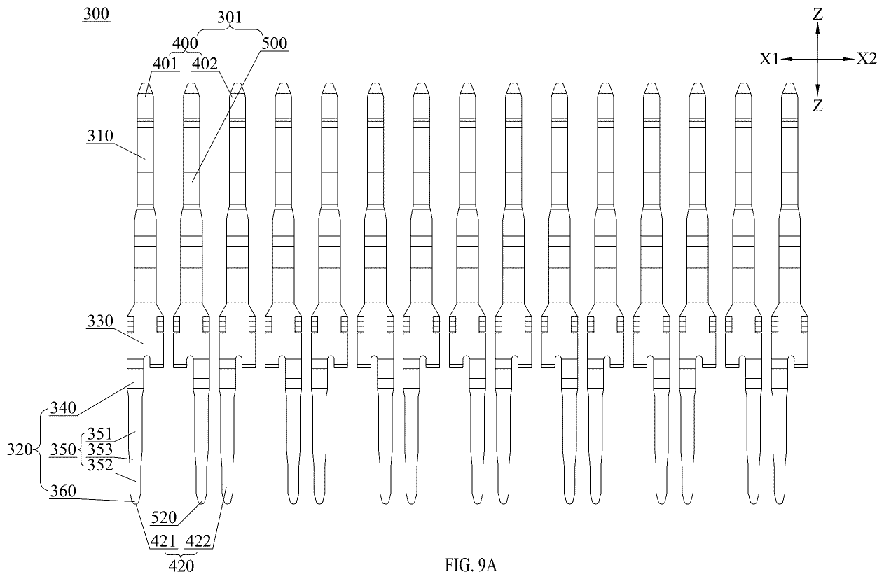

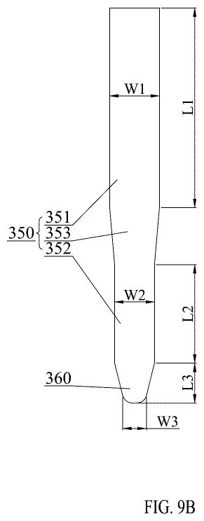

Exemplarily, as shown in FIG. 9B, the length L1 of the first mounting subportion 351 (i.e., the size along the vertical direction Z-Z) may be greater than the length L2 of the second mounting subportion 352 (i.e., the size along the vertical direction Z-Z). In this way, the conductive element 301 has a preferable mechanical strength, so that it is not prone to deform or damage. By example, as shown in FIG. 9B, the length L1 of the first mounting subportion 351 may be greater than twice the length L2 of the second mounting subportion 352. In this way, the conductive element 301 has enough mechanical strength to be unlikely to deform or damage.

Exemplary, as shown in FIG. 9B, the length L3 of the mounting end 360 may be between 0.15 mm and 0.25 mm. Preferably, the length L3 can be between 0.18 mm and 0.22 mm. More preferably, the length L3 can be between 0.19 mm and 0.21 mm. Exemplary, the longitudinal width W3 of the tip of the mounting end 360 may be between 0.05 mm and 0.15 mm. Preferably, the longitudinal width W3 may be between 0.08 mm and 0.12 mm. More preferably, the longitudinal width W3 can be between 0.09 mm and 0.11 mm. In this way, the mounting end 360 has sufficient strength, and the printed circuit board, such as the metal layer on the sidewall of the through-hole (PTH through-hole), cannot be scratched during the installation.

Typically, the inner diameter of the through-hole is 0.40±0.05 mm. Based on this, in the worst case, the gap between the tip of the mounting end 360 and the sidewall of the through-hole is:
(0.40±0.05 mm−0.10±0.05 mm)/2,

It is between 0.10 mm and 0.20 mm. The gap is sufficient.

Considering the actual position of the tip of the mounting end 360 relative to the through-hole, as for maximum material condition (MMC), the tip of the mounting end 360 is biased to one side 0.10−0.08/2−0.12/2=0, while on the other side, the gap between the tip of the mounting end 360 and the sidewall of the through-hole is 0.20 mm. As for minimum material requirement (LMC), the tip of the mounting end 360 is biased to one side 0.20−0.08/2−0.12/2=0.10, while on the other side, the gap between the tip of the mounting end 360 and the sidewall of the through-hole is 0.30 mm. Thus, the risk for the mounting end 360 not being able to be inserted into the through-hole is low.

Exemplarily, as shown in FIG. 9B, the longitudinal width W1 of the first mounting subportion 351 may be between 0.22 mm and 0.28 mm. Preferably, the longitudinal width W1 may be between 0.23 mm and 0.27 mm. More preferably, the longitudinal width W1 may be between 0.24 mm and 0.26 mm. The longitudinal width W2 of the second mounting subportion 352 may be between 0.17 mm and 0.23 mm. Preferably, the longitudinal width W2 may be between 0.18 mm and 0.22 mm. More preferably, the longitudinal width W2 may be between 0.19 mm and 0.21 mm. This helps balance the mechanical strength of the through-hole mounting tail 350 and minimum of the sidewall of the through-hole mounting tail 350 in inclined angle so as to ensure a more smooth insertion of the through-hole mounting tail 320 into the through-hole in the printed circuit board 800.

Exemplarily, as shown in FIG. 6-9A, a plurality of conductive elements 301 may include a plurality of first-type conductive elements 400 and a plurality of second-type conductive elements 500. The plurality of first-type conductive elements 400 are substantially the same in structure. The plurality of second-type conductive elements 500 are substantially the same in structure, which is different from that of the first-type conductive elements 400. In each set of the lead assemblies 300, the numbers of the first-type conductive elements 400 and the second-type conductive elements 500 may be the same or different. Preferably, in each set of the lead assemblies 300, the first-type conductive elements 400 may be one more than the second-type conductive elements 500, whereby each second-type conductive element 500 is located between adjacent two first-type conductive elements 400. The plurality of first-type conductive elements 400 and the plurality of second-type conductive elements 500 may be alternately arranged along the longitudinal direction X1-X2. That is, along the longitudinal direction X1-X2, two adjacent first-type conductive elements 400 are provided with a second-type conductive element 500 therebetween, and two adjacent second-type conductive elements 500 are provided a first-type conductive element 400 therebetween. The first-type conductive element 400 and the second-type conductive element 500 adjacent to each other may be spaced apart to ensure that they are electrically insulated from each other. Before the lead assemblies 300 are mounted into the insulating housing 200, the first-type conductive elements 400 and the second-type conductive elements 500 may be held together by a lead frame (not shown).

The second-type conductive elements 500 each has a first adjacent first-type conductive element located on its first side and a second adjacent first-type conductive element located on its second side. The first and second sides can be opposed to each other along the longitudinal direction X1-X2. As shown in FIGS. 7-9A, the second-type conductive element 500 has a first adjacent first-type conductive element (e.g., 401) located on its left side and a second adjacent first-type conductive element (e.g., 402) located on its right side. When the number of the first-type conductive elements 400 is equal to or less than the number of the second-type conductive elements 500, the second-type conductive element 500 at the end may have only a first-type conductive element 400 located on one side thereof. When the number of first-type conductive elements 400 is greater than the number of second-type conductive elements 500, the second-type conductive elements 500 located at the ends may have first-type conductive elements 400 on both sides.

Each of the second-type conductive elements 500 may have two first-type conductive elements 400 on opposite sides. For a second-type conductive element 500 having two first-type conductive elements 400 on both sides, the distances from the through-hole mounting tail 520 of the second-type conductive element 500 to the through-hole mounting tails 420 of its adjacent two first-type conductive elements 400 are not equal. The first-type conductive element 400 with its through-hole mounting tail is far from the through-hole mounting tail 520 of the second-type conductive element 500 may be referred to as the first adjacent first-type conductive element 401, and the through-hole mounting tail of the first adjacent first-type conductive element 401 is indicated by 421. The first-type conductive element 400 with its through-hole mounting tail is close to the through-hole mounting tail 520 of the second-type conductive element 500 may be referred to as the second adjacent first-type conductive element 402, and the through-hole mounting tail of the second adjacent first-type conductive element 402 is indicated by 422. Accordingly, the through-hole mounting tail 520 is relatively far from the through-hole mounting tail 421 of the first adjacent first-type conductive element 401, and closer to the through-hole mounting tail 422 of the second adjacent first-type conductive element 402. It can be understood that for a neighboring second-type conductive element with the current second-type conductive element 500, the second adjacent first-type conductive element 402 of the current second-type conductive element 500 will be a first adjacent first-type conductive element of the neighboring second-type conductive element, and a second adjacent first-type conductive element of the neighboring second-type conductive element would be used as a first adjacent first-type conductive element of the next neighboring second-type conductive element.

Thus, in the lead assembly 300 provided by the present disclosure, the through-hole mounting tail 520 of the second-type conductive element 500 is closer to the through-hole mounting tail 422 of the second adjacent first-type conductive element 402, the second-type conductive element 500 and the second adjacent first-type conductive element 402 may be configured as a pair of conductive elements for transferring differential signals. The through-hole mounting tail 520 is far from the through-hole mounting tail 421 relatively, and the second-type conductive element 500 and the first adjacent first-type conductive element 401 may belong to different differential signal conductive element pairs respectively. Thus, when the lead assembly 300 is applied to the electrical connector 100, less crosstalk is happened between the through-hole mounting tail 520 and the through-hole mounting tail 421, thereby avoiding the degradation of SI performance, which meeting the requirements of the DDR5 electrical connector for SI performance. Further, the distance between the through-hole mounting tail 520 and the through-hole mounting tail 421 is larger, and the distance between the corresponding through-holes in the printed circuit board 800 is also larger, thereby providing sufficient space for routing the conductive traces in the printed circuit board 800. The difficulty of the routing in the printed circuit board 800 is reduced. Further, in the electrical connector 100 with the lead assembly 300, the first-type conductive elements 400 and the second-type conductive elements 500 may be connected to the printed circuit board by the through hole technology. Compared to the surface mount technology for connecting the conductive elements, the anti-warpage performance of the insulating housing for holding these conductive elements may be required less in the through hole technology. In this way, the insulating housing 200 may formed with more housing cavities and more stamping die cavities, and the lead assembly 300 can be assembled more easily and at lower cost.

As shown in FIG. 11, there is a distance A between the through-hole mounting tail 520 of the second-type conductive element 500 and the through-hole mounting tail 421 of its adjacent first adjacent first-type conductive element 401, and there is a distance B between the through-hole mounting tail 520 of the second-type conductive element 500 to the through-hole mounting tail 422 of its adjacent second adjacent first-type conductive element 402. A is greater than B. Typically, as shown in FIGS. 7-9A, the distance from the intermediate portion 330 of each second-type conductive element 500 to the intermediate portion 330 of the first adjacent first-type conductive element 401 is equal to the distance to the intermediate portion 330 of the second adjacent first-type conductive element 402. The through-hole mounting tail 421 of the first adjacent first-type conductive element 401 may be offset in a direction away from the second-type conductive element 500 relative to the intermediate portion 330. This offset can be achieved by connecting the through-hole mounting tail 421 non-centrally with respect to the intermediate portion 330, or by connecting it centrally but with torsion or bending. Accordingly, since the first adjacent first-type conductive element 401 and the second adjacent first-type conductive element 402 have substantially the same structure, the through-hole mounting tail 422 of the second adjacent first-type conductive element 402 will be offset in the direction towards the second-type conductive element 500. These can cause A greater than B. In order to increase the difference between A and B, the through-hole mounting tail 520 of the second-type conductive element 500 may be offset in the direction towards the through-hole mounting tail 422 of the second adjacent first-type conductive element 402. This offset can be achieved by connecting the through-hole mounting tail 520 non-centrally with respect to the intermediate portion 330, or by connecting it centrally but with torsion or bending. Alternatively or additionally, the through-hole mounting tail 520 of the second-type conductive element 500 may also be aligned with the center of its intermediate portion 330. Alternatively, the through-hole mounting tail 520 of the second-type conductive element 500 may be slightly offset in the direction towards the through-hole mounting tail 421 of the first adjacent first-type conductive element 401, provided that A is greater than B. Optionally, the through-hole mounting tail 421 of the first adjacent first-type conductive element 401 and the through-hole mounting tail 422 of the second adjacent first-type conductive element 402 may also be not offset relative to the respective intermediate portions, but aligned with the center of the respective intermediate portions. In this case, the through-hole mounting tail 520 of the second-type conductive element 500 may be offset in the direction towards the through-hole mounting tail 422 of the second adjacent first-type conductive element 402. It can also ensure A greater than B.

For the “offset” mentioned above, it can be carried out in the longitudinal direction X1-X2, in the transverse direction Y1-Y2, or in the longitudinal direction X1-X2 and the transverse direction Y1-Y2 at the same time, or in a direction that has an angle with both the longitudinal X1-X2 and the transverse direction Y1-Y2.

Exemplarily, as shown in FIG. 9A, for the second-type conductive elements 500 having first adjacent first-type conductive elements 401 and second adjacent first-type conductive elements 402 on both sides respectively, the center distance A1 from the through-hole mounting tail 520 of each second-type conductive element 500 to the through-hole mounting tail 421 of the first adjacent first-type conductive element 401 along longitudinal direction X1-X2 may be greater than the center distance B1 from the through-hole mounting tail 520 to the through-hole mounting tail 422 of the second adjacent first-type conductive element 402 along longitudinal direction X1-X2. The distance A can be determined by the center distance A1 alone. The distance B can also be determined by the center distance B1 alone. That is, the through-hole mounting tail 520 may be closer to the through-hole mounting tail 422 of the second adjacent first-type conductive element 402 than the through-hole mounting tail 421 of the first adjacent first-type conductive element 401 by offsetting the through-hole mounting tail(s) of the first-type conductive element 400 and/or the second-type conductive element 500 only in longitudinal direction X1-X2. Thereby the distance A is greater than the distance B. As shown in FIG. 11, the center of the through-hole mounting tail 420 of the first-type conductive element 400 is offset towards the second longitudinal direction X1 (e. g., to the right) relative to the center of the intermediate portion 330 by a first longitudinal offset distance, which is Dₓ, and the center of the through-hole mounting tail 520 of the second-type conductive element 500 is offset towards to the second longitudinal direction X2 (e. g., to the left) relative to the center of the intermediate portion 330 by a second longitudinal offset distance, which is also Dₓ. Thus, the center distance A1 from the through-hole mounting tail 421 of the first adjacent first-type conductive element 401 on the left side of the second-type conductive element 500 to the through-hole mounting tail 520 is D₀+2 Dₓ, wherein Do is a center distance of the intermediate portions 330 of any adjacent first-type conductive element 400 and the second-type conductive element 500. The center distance B1 from the through-hole mounting tail 422 of the second adjacent first-type conductive element 402 on the right side of the second-type conductive element 500 to the through-hole mounting tail 520 is D₀-2 Dₓ. This causes that the center distance A1 could be as large as possible and the center distance B1 could be as small as possible. Preferably, the center distance B1 may be at least equal to the size of the gap between the adjacent intermediate portion 330, such that the gap between the adjacent two through-hole mounting tails may be not too small to affect the SI performance. Alternatively or additionally, the center distance B1 may be limited by the size of the gap between the adjacent middle part 330.

It should be noted that the first longitudinal offset distance of the through-hole mounting tail 420 of the first-type conductive element 400 relative to the intermediate portion 330 may be unequal to the second longitudinal offset distance of the through-hole mounting tail 520 of the second-type conductive element 500 relative to the intermediate portion 330. For example, one of them is not equal to Dₓ. Further, A1 greater than B1 can be achieved merely through offsetting the through-hole mounting tail 420 of the first-type conductive element 400 towards the first longitudinal direction X1, or merely through offsetting the through-hole mounting tail 520 of the second-type conductive element 500 towards the second longitudinal direction X2.

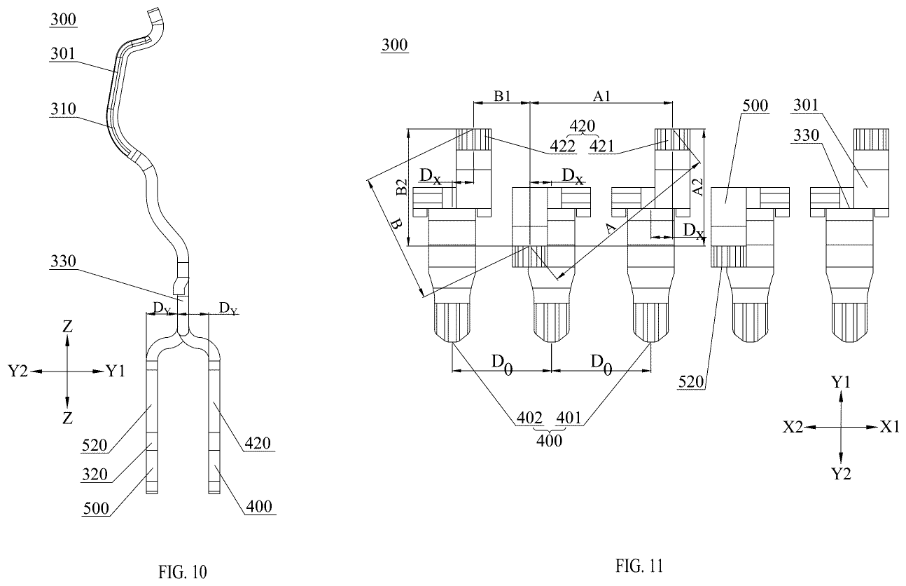

As shown in FIG. 10, the through-hole mounting tail 420 of the first-type conductive element 400 may be offset along the first transverse direction Y1 relative to the intermediate portion 330 by a first transverse offset distance, e.g., D^{Y}. The through-hole mounting tail 520 of the second-type conductive element 500 may be offset along the second transverse direction Y2 relative to the intermediate portion (not shown in FIG. 10, because it is blocked by the first-type conductive element 400) by a second transverse distance, e.g., D^{Y}. The first transverse direction Y1 and the second transverse direction Y2 are two opposite directions. The first transverse offset distance and the second transverse offset distance can be equal, that is, both are D^{Y}. Alternatively or additionally, the first transverse offset distance and the second transverse offset distance may be unequal. Even, one or both of the first transverse offset distance and the second transverse offset distance can be zero. As shown in FIG. 11, in the case of the through-hole mounting tail 420 of the first-type conductive element 400 offset D_{Y} relative to its intermediate portion 330, and the through-hole mounting tail 520 of the second-type conductive element 500 offset D^{Y} relative to its intermediate portion 330, it is 2D^{Y} for the distance A2 between the through-hole mounting tail 421 of the first adjacent first-type conductive element 401 and the through-hole mounting tail 520 of the second-type conductive element 500 along the transverse direction Y1-Y2, and it is also 2D^{Y} for the distance B2 between the through-hole mounting tail 422 of the second adjacent first-type conductive element 402 and the through-hole mounting tail 520 of the second-type conductive element 500 along the longitudinal direction Y1-Y2. In this case, distance A is determined by distances A1 and A2, and distance B is determined by distances B1 and B2. The distance A between the through-hole mounting tail 421 of the first adjacent first-type conductive element 401 and the through-hole mounting tail 520 of the second-type conductive element 500 may be further increased because of the distance A2, and the distance B between the through-hole mounting tail 422 of the second adjacent first-type conductive element 402 and the through-hole mounting tail 520 of the second-type conductive element 500 may be further increased because of the distance B2. Thus, the crosstalk caused by the adjacent through-hole mounting tails being too close to each other can be avoided, thereby improving the SI performance. Moreover, there may be a sufficient gap for forming conductive traces in the printed circuit board corresponding to the through-hole mounting tail 421 of the first adjacent first-type conductive element 401 and the through-hole mounting tail 520 of the second-type conductive element 500.

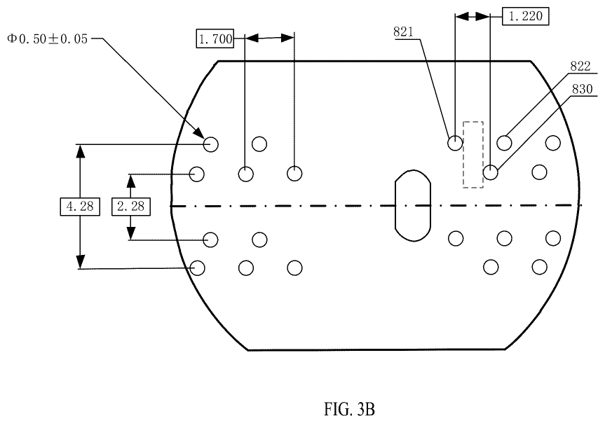

FIGS. 3A-3B shows an exemplary embodiment of the present disclosure of the printed circuit board 800 from the backside. As shown, the printed circuit board 800 is provided with a footprint 810. The footprint 810 is used to connect any of the electrical connectors 100 described herein, the footprint 810 may be understood as the area on the printed circuit board 800 covered by the electrical connector 100. The footprint 810 is provided with a plurality of through-holes passing through the front and back of the printed circuit board 800. The back surface of the printed circuit board 800 may be provided with a plurality of pads (not shown), each of the plurality of through-holes passes through a corresponding pad. The aperture of the through-hole can be between 0.35 mm and 0.45 mm. For a DDR5 electrical connector under the JEDEC specification can be provided with 288 through-holes with apertures ranging from 0.35 mm to 0.45 mm. The through-hole mounting tails 320 of the conductive elements 301 of the lead assembly 300 in the electrical connector 100 may be correspondingly inserted into the plurality of through-holes, and soldered to their respective pads.

The through-holes may include a plurality of first through-holes 820 and a plurality of second through-holes 830. The plurality of first through-holes 820 and the plurality of second through-holes 830 are alternately arranged along a longitudinal direction. The plurality of first through-holes 820 and the plurality of second through-holes 830 may also be arranged longitudinally in a reference line, or arranged on both sides of the reference line. The electrical connector 100 may be mounted to the front of the printed circuit board 800. The through-hole mounting tails 420 of the plurality of first-type conductive elements 400 of the lead assembly 300 in the electrical connector 100 may be inserted to the plurality of first through-hole 820 correspondingly, and soldered to their respective pads. The through-hole mounting tails 520 of the plurality of second-type conductive element 500 of the lead assembly 300 in the electrical connector 100 may be inserted to the plurality of second through-hole 830 correspondingly, and soldered to their respective pads. In terms of structure and size, there is almost no difference between the plurality of first through-hole 820 and the plurality of second through-hole 830. The first through-holes 820 and the second through-holes 830 are arranged in four rows within the footprint 810. There are a row of first through-holes 820 and a row of second-through-holes 830 on one side of the card slot, and there is another row of first through-holes 820 and another row of second through-holes 830 on the other side of the card slot. Each row of through-holes extends along the longitudinal direction X1-X2. For example, the center distance between the second row of through-holes and the third row of through-holes can be 2.28±0.05 mm. The center distance between the first row of through-holes and the fourth row of through-holes can be 4.28±0.05 mm. Thus, the center distance between the adjacent rows of first through-holes 820 and second through-holes 830 is roughly 1.0±0.05 mm. In the embodiments described above that the through-hole mounting tails 420 of the first-type conductive elements 400 is offset along the first transverse direction Y1 relative to the intermediate portions 330 by the first transverse distance, and the through-hole mounting tails 520 of the second-type conductive elements 500 is offset along the second transverse direction Y2 relative to the intermediate portions 330 by the second transverse offset distance, the center distance between adjacent rows of first through-holes 820 and second through-holes 830 is increased. If the through-hole mounting tails 420 of the first-type conductive elements 400 and the through-hole mounting tails 520 of the second-type conductive elements 500 are not offset along the transverse direction Y1-Y2, the adjacent rows of first through-holes 820 and second through-holes 830 may be arranged in a row. It is not precluded by the present disclosure.

For each of those second through-holes 830 between the first through-holes 820, the first through-hole 821 on its first side (e. g., left side in FIGS. 3A-3B) and the first through-hole 822 on its second side (e. g., right side in FIGS. 3A-3B) are the first adjacent first through-hole and the second adjacent first through-hole, respectively. For clarity, the first adjacent first through-hole is indicated by 821, and the second adjacent first through-hole is indicated by 822. The first and second sides are opposite to each other along the longitudinal direction X1-X2. And, each second through-hole 830 is closer to the second adjacent first through-hole 822 than the first adjacent first through-hole 821. Each second through-hole 830 is asymmetrically disposed between the first adjacent first through-hole 821 and the second adjacent first through-hole 822. This allows a sufficient gap between the second through-hole 830 and the first adjacent first through-hole 821, which is indicated by the dotted box in FIG. 3B. Under the JEDEC specification, the center distance between the two adjacent first through-holes 820 in a row may be 1.7±0.05 mm. Similarly, the center distance between two adjacent second through-holes 830 in a row may also be 1.7±0.05 mm. Typically, along the longitudinal direction X1-X2, the center distance between the second through-hole 830 to the second adjacent first through-hole 822 may be 1.220±0.05 mm. Thus, the gap between the second through-hole 830 and the first adjacent first through-hole 821 along the longitudinal direction may be 1.22 mm−0.5 mm=0.72 mm. This creates a large enough routing space in the printed circuit board. However, this asymmetrical arrangement results in a center distance of 0.480 mm±0.05 mm between the second through-hole 830 and the second adjacent first through-hole 822. The diameter of each of the through-holes is approximately 0.50±0.05 mm, and the through-holes are formed on the corresponding pads. Typically, the diameter of the pads is approximately 0.85±0.05 mm. If the center distance between the second through-hole 830 and the second adjacent first insert through-hole 822 is too close, it may cause the pads of the two through-holes to be shorted. Therefore, for a DDR5 electrical connector, the through-hole mounting tails 420 of the first-type conductive elements 400 and the through-hole mounting tails 520 of the second-type conductive elements 500 have to offset in the opposite two directions along the transverse direction, respectively. For other types of electrical connectors, if the center distance between the second through-hole 830 and the adjacent second adjacent first through-hole 822 is larger, the through-hole mounting tails of the conductive elements in the corresponding electrical connector may not be necessary to offset relative to the bodies of the conductive elements or only a part of the through-hole mounting tails are offset.

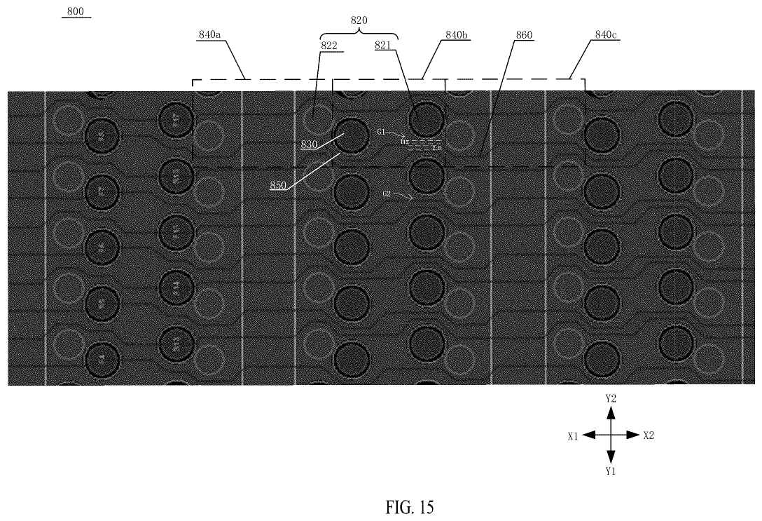

Such asymmetric arrangement of the second through-hole 830 between the first adjacent first through-hole 821 and the second adjacent first through-hole 822, may form a larger space between the second through-hole 830 and the first adjacent first through-hole 821. This space can be used for routing traces in the printed circuit board. FIG. 15 illustrates a portion of the routing layer in the footprint of the printed circuit board according to an exemplary embodiment of the present disclosure. As shown in FIG. 15, each second through-hole 830 and its first adjacent first through-hole 821 forms a group, such as groups 840a, 840b and 840c. In two adjacent groups, the first through-hole 820 and the second through-hole 830 in the group 840b are surrounded by anti-pads 850 respectively, while the first through-hole 820 and the second through-hole 830 in the other group are provided with no anti-pad. For example, the first through-holes and the second through-holes in group 840a and 840c are provided with no anti-pad. The groups with the anti-pads and the groups without any anti-pad are alternately arranged along longitudinal direction X1-X2. The second through-hole 830 and the first adjacent first through-hole 821 within group 840b may be surrounded by the anti-pads 850. The printed circuit board 800 is manufactured, for example, by patterning conductive layers (e. g., copper layers) and removing a portion of the conductive layers around the second through-hole 830 and the first adjacent first through-hole 821, such that the anti-pads 850 are formed. The anti-pads 850 form a ground clearance around the second through-hole 830 and the first adjacent first through-hole 821 for transmitting signals, such that the dielectric sheet in the attachment layer is exposed. The area where the conductive layer is removed can be called as a “non-conductive area” or an “anti-pad”. The anti-pads has a size and shape to preclude shorting of the conductive layer to the second through-hole 830 and the first adjacent first through-hole 821, even if there is some imprecision in the formation of the second through-hole 830 and the first adjacent first through-hole 821 relative to the conductive layer, and to establish a desired impedance of the signal path formed by the second through-hole 830 and the first adjacent first through-hole 821. In FIG. 15, the anti-pads 850 are circular in shape. The diameter of the anti-pads 850 can be 1.2±0.05 mm. However, the anti-pads 850 may have any suitable shape. In the transverse direction Y1-Y2, there are areas G1 between the two adjacent groups, which correspond to the card slot in the electrical connector 100, or there are arcas G2 corresponding to the gaps between the conductive elements on the adjacent two electrical connectors 100, so that the anti-pads 850 of the two adjacent groups may have larger gaps along the transverse direction Y1-Y2. The conductive traces 860 may run between the anti-pads 850. The gap m between the conductive trace 860 and the anti-pad 850 may be greater than or equal to 0.08 mm, for example, equal to 0.08 mm, 0.09 mm, 0.10 mm, 0.11 mm, 0.12 mm, and so on. The gap n between adjacent conductive traces 860 may be greater than or equal to 0.08 mm, for example, equal to 0.08 mm, 0.09 mm, 0.10 mm, 0.11 mm, 0.12 mm, and so on. This gap n is the narrowest portion between adjacent conductive traces 860.

Further, a shadow ground via (not shown) may be provided between each of the second through-holes 830 and its second adjacent first through-hole 822. The second through-holes 830 and the second adjacent first through-holes 822 may be used to transmit pairs of differential signals. The shadow ground vias are not required to accept the through-hole mounting tail of the electrical connector and are configured and positioned relative to signal vias to improve performance, particularly at high frequencies. In some embodiments, the shadow ground vias reduce crosstalk between signal vias in adjacent rows of signal vias in the footprint. In some embodiments, the shadow vias are located between signal vias of a differential signal pair. The centers of the shadow ground vias may be located in the connection line of the centers of the second through-holes 830 and the second adjacent first through-holes 822, respectively. The diameter of the shadow ground vias may be smaller than the diameters of the second through-holes 830 and the second adjacent first through-holes 822. The shadow ground vias may be uniformly spaced apart from the second through-holes 830 and the second adjacent first through-holes 822. A conductive material can be formed (e. g. plated or filled) within the shadow ground vias. The conductive material is electrically connected to the ground layers. Optionally, the shadow ground vias may include a slot-shaped shadow ground via. The shadow ground vias can extend through multiple conductive layers of the printed circuit board.

The distance from each second insertion through-hole 830 to its first adjacent first through-hole 821 is greater than the distance to its second adjacent first through-hole 822, which can be achieved by offsets in multiple directions. By example, the distance from the second through-hole 830 to the first adjacent first through-hole 821 is greater than the distance from the second through-hole 830 to the second adjacent first through-hole 822 along the longitudinal direction X1-X2. By example, the centers of the plurality of first through-holes 820 and the centers of the plurality of second through-hole 830 may be located on both sides of a reference line extending along the longitudinal direction. The reference line may be determined by the intermediate portions 330 of the first-type conductive elements 400 and the intermediate portions 330 of the second-type conductive elements 500. By example, the distance from the plurality of first through-holes 820 to the reference line is equal to the distance from the plurality of second through-holes 830 to the reference line along the transverse direction Y1-Y2.

Exemplarily, as shown in FIGS. 7-9A, the mating contact portions 310 of the plurality of first-type conductive elements 400 and the mating contact portions 510 of the plurality of second-type conductive elements 500 are equally spaced in the first line along the longitudinal direction X1-X2. The mating contact portions 410 and the mating contact portions 510 are used for electrical contact with the golden fingers on the add-in card 700. By example, the intermediate portion 330 of the first-type conductive elements 400 and the intermediate portion 330 of the second-type conductive elements 500 may be equally spaced into the second line along the longitudinal direction X1-X2. The first line can be parallel to the second line. The reference line is parallel to the second line and aligned with the second line in the vertical direction Z-Z. The mating contact portions 410 and the mating contact portion 510s are equally spaced in the straight line, not only for cooperating with the golden fingers of the add-in card, but also to maintain balanced impedances along their extension direction. One of the purposes of the intermediate portions 330 equally spaced in the second line is also to maintain balanced Impedances. Exemplarily, as shown in FIGS. 7-9A, the through-hole mounting tails 420 of the plurality of first-type conductive elements 400 may have equal spacings therebetween. By example, the through-hole mounting tails 520 of the plurality of second-type conductive elements 500 may have equal spacings therebetween.

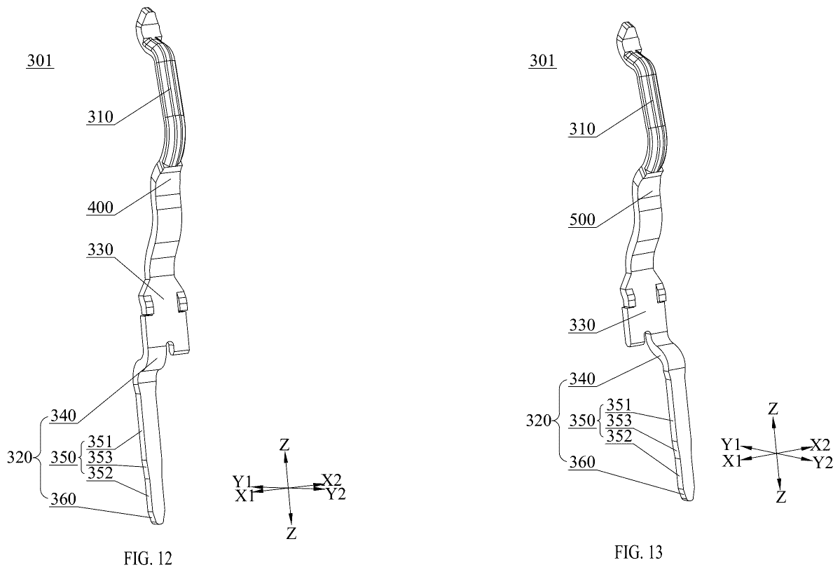

In the illustrated embodiment, the through-hole mounting tail 420 of the first-type conductive element 400 is offset along both the longitudinal direction X1-X2 and the transverse direction Y1-Y2 relative to the intermediate portion 330, as shown in FIG. 12. The through-hole mounting tail 420 may be disposed on one side of the intermediate portion 330, so that the through-hole mounting tail 420 is offset along the first longitudinal direction X1 relative to the intermediate portion 330. In particular, as shown in FIGS. 7-9A, for each of the plurality of first-type conductive elements 400, the intermediate portion connecting portion 340 of the through-hole mounting tail 420 may be connected to the first side of the intermediate portion 330. When the first adjacent first-type conductive element 401 is located on the first side of the second-type conductive element 500, the through-hole mounting tail 420 is also connected to the first side of the intermediate portion 330. In the illustrated embodiment, the first side is the side corresponding to the first longitudinal direction X1. Thus, the through-hole mounting tail 421 may be away from the through-hole mounting tail 520 along the longitudinal direction X1-X2, and the through-hole mounting tail 422 may be close to the through-hole mounting tail 520 along the longitudinal direction X1-X2. The distance between the through-hole mounting tail 520 and the through-hole mounting tail 421 of the first adjacent first-type conductive element 401 may be greater than the distance between through-hole mounting tail 520 and the through-hole mounting tail 422 of the second adjacent first-type conductive element 402 along the longitudinal direction X1-X2. The through-hole mounting tail 420 is bent towards the first transverse direction Y1 relative to the intermediate portion 330.

In the illustrated embodiment, the through-hole mounting tail 520 of the second-type conductive element 500 is offset along both the longitudinal direction X1-X2 and the transverse direction Y1-Y2 relative to the intermediate portion 330, as shown in FIG. 13. The through-hole mounting tail 520 may be disposed on the other side of the intermediate portion 330, so that the through-hole mounting tail 520 is offset in the second longitudinal direction X2 relative to the intermediate portion 330. Further, as shown in FIG. 7-9A, the intermediate portion connecting portion 340 of the through-hole mounting tail 520 of each of the second-type conductive elements 500 may be connected to the second side of the intermediate portion 330. When the second adjacent first-type conductive element 402 is located on the second side of the second-type conductive element 500, the through-hole mounting tail 520 is also located on the second side of the intermediate portion 330. In the illustrated embodiment, the second side is the side corresponding to the second longitudinal direction X2. The through-hole mounting tail 421 may be farther away from the through-hole mounting tail 520 along the transverse direction Y1-Y2, and the through-hole mounting tail 422 may be closer to the through-hole mounting tail 520 along the transverse direction Y1-Y2. The through-hole mounting tail 520 is bent towards the second transverse direction Y2 relative to the intermediate portion 330.

Although the aforementioned offsets of the through-hole mounting tail 420 and through-hole mounting tail 520 in different directions is obtained by misalignment and bending, but in other embodiments not shown, the offsets may also be achieved by twisting and the like. Alternatively, the offsets in different directions can also be achieved in the same way, for example by bending. By example, an edge of the through-hole mounting tail 420 may be flush with an edge of the first side of the intermediate portion 330. An edge of the through-hole mounting tail 520 may be flush with an edge of the second side of the intermediate portion 330.

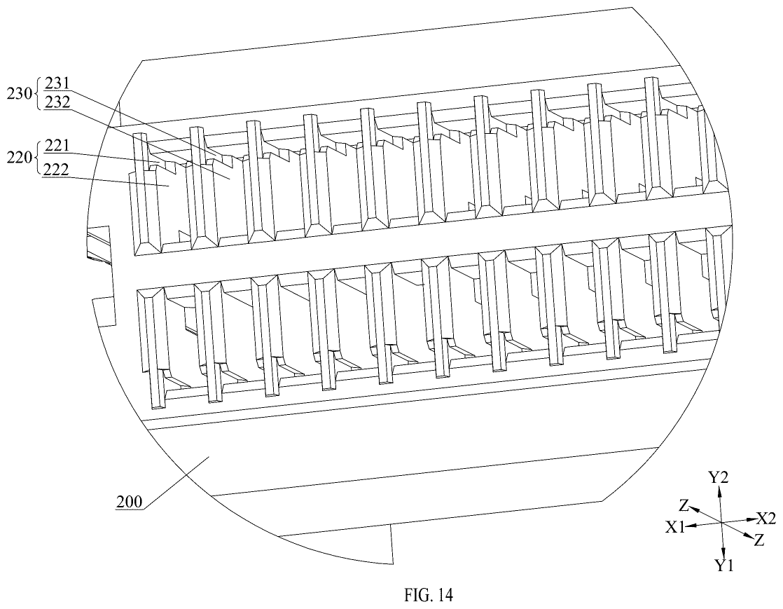

For example, the insulating housing 200 may be provided with a plurality of mounting cavities. The plurality of first-type conductive elements 400 and the plurality of second-type conductive elements 500 may be mounted in the plurality of mounting cavities correspondingly. The cross-portional area of the portions of the mounting cavities accommodating the through-hole mounting tails 420 and the through-hole mounting tails 520 may be greater than the cross-portional area of the other portions. As shown in FIGS. 6 and 14, the plurality of mounting cavities may include a plurality of first mounting cavities 220. The plurality of first-type conductive elements 400 may be correspondingly inserted into the plurality of first mounting cavities 220 from the mounting surface. The first mounting cavities 220 each may include a first portion 221 and a second portion 222 connected to each other. The intermediate portion 330 of the first-type conductive element 400 is inserted into the first portion 221, and the intermediate portion connecting portion 340 may be accommodated in the second portion 222. The intermediate portion 330 is located on one side of the second portion 222 after inserted into the first portion 221, and the mounting main portion 350 and the mounting end 360 of the through-hole mounting tail 420 extend from the side opposite the intermediate portion 330 beyond the mounting surface 202. The intermediate portion connecting portion 340 may occupy more space in the insulating housing 200 because it is curved, so that the second portion 222 is larger in volume. The second portion 222 may extend upwardly to the interfacing surface 201. Alternatively or addtionally, the second portion 222 may extend only to the upper end of the first portion 221. The second portion 222 can be centrally aligned with the first portion 221 along the longitudinal direction X1-X2, so that a part of the second portion 222 along the longitudinal direction X1-X2 is not occupied by the intermediate portion connecting portion 340. The first mounting cavity 220 may be configured to, alternatively, hold the second-type conductive element 500. Further, the second portion 222 is large enough in volume to enable the first-type conductive element 400 to be more conveniently inserted into the first mounting cavity 220. Compared with the SMT, the size of the mounting cavities in the insulating housing 200 of the electrical connector may be larger, since the soldering process of the THT is performed at the back side of the printed circuit board opposed to the electrical connector, without considering the warpage problem during the soldering process. And when considering the warpage problem, it is necessary to ensure that the insulating housing 200 has sufficient wall thickness and the mounting cavities would be smaller. The larger first mounting cavities 220 can provide great convenience for mounting the first-type conductive elements 400 into the insulating housing 200. It can greatly reduce the difficulty of installation and lower requirements on assembling devices, and the costs and scrap rate are reduced. Further, the larger first mounting cavities 220 cannot be completely filled by the first-type conductive elements 400, which is also advantageous to the heat dissipation of the first-type conductive elements 400.

As shown in FIGS. 6 and 14, the mounting cavities may include a plurality of second mounting cavities 230. The plurality of second-type conductive elements 500 may be correspondingly inserted into the plurality of second mounting cavities 230. The second mounting cavities 230 each may include a third portion 231 and a fourth portion 232 communicated to each other. The intermediate portion 330 of the second-type conductive element 500 is inserted into the third portion 231, and the intermediate portion connecting portion 340 may be accommodated in the fourth portion 232. The intermediate portion 330 is located on one side of the fourth portion 232 after inserted into the third portion 231, and the mounting main portion 350 and the mounting end 360 of the through-hole mounting tail 520 extend from the side opposite the intermediate portion 330 beyond the mounting surface 202. The intermediate portion connecting portion 340 may occupy more space in the insulating housing 200 because it is curved, so that the fourth portion 232 is larger in volume. The fourth portion 232 may extend upwardly to the interfacing surface 201. The fourth portion 232 may extend only to the upper end of the third portion 231. The fourth portion 232 can be centrally aligned with the third portion 231 along the longitudinal direction X1-X2, so that a part of the fourth portion 232 along the longitudinal direction X1-X2 is not occupied by the intermediate portion connecting portion 340. The second mounting cavity 230 may be the same as the first mounting cavity 220 in structure, for mounting any type of conductive element as required. Similar to the benefits mentioned above, the fourth portion 232 is large enough in volume to enable the second-type conductive element 500 to be more conveniently inserted into the second mounting cavity 230, regardless of the warpage problem during soldering. Therefore, the installation difficulty and requirements on assembling devices can be greatly reduced, and the costs and scrap rate are reduced. Also, it is advantageous to the heat dissipation of the second-type conductive element 500.

The present disclosure has been described through the above embodiments, but it should be understood that a variety of variations, modifications and improvements may be made by a person skilled in the art according to the teaching of the present disclosure, and these variations, modifications and improvements all fall within the spirit of the present disclosure and the claimed scope of protection of the present disclosure. The scope of protection of the present disclosure is defined by the appended claims and its equivalent scope. The above embodiments are only for the purpose of illustration and description, and are not intended to limit the present disclosure to the scope of the described embodiments.

In the description of the present disclosure, it is to be understood that orientation or positional relationships indicated by orientation words “front’, “rear”, “upper”, “lower”, “left”, “right”, “transverse direction”, “vertical direction”, “perpendicular”, “horizontal”, “top”, “bottom” and the like usually are shown based on the accompanying drawings, only for the purposes of the case in describing the present disclosure and simplification of its descriptions. Unless stated to the contrary, these orientation words do not indicate or imply that the specified apparatus or element has to be specifically located, and structured and operated in a specific direction, and therefore, should not be understood as limitations to the present disclosure. The orientation words “inside” and “outside” refer to the inside and outside relative to the contour of each component itself.

Various changes may be made to the illustrative structures shown and described herein. For example, the lead assembly may be used in any suitable electrical connectors, such as backplane connectors, daughter card connectors, stacking connectors, Mezzanine connectors, I/O connectors, chip sockets, Gen Z connectors, etc. The lead assembly may significantly improve signal integrity (SI) of the electrical connector.

Moreover, although many creative aspects have been described above with reference to the vertical connector, it should be understood that the aspects of the present disclosure are not limited to these. Any one of the creative features, whether alone or combined with one or more other creative features, can also be used for other types of electrical connectors, such as coplanar connectors, orthogonal connectors, right angle connectors.

For facilitating description, the spatial relative terms such as “on”, “above”, “on an upper surface of” and “upper” may be used here to describe a spatial position relationship between one or more components or features and other components or features shown in the accompanying drawings. It should be understood that the spatial relative terms not only include the orientations of the components shown in the accompanying drawings, but also include different orientations in use or operation. For example, if the component in the accompanying drawings is turned upside down completely, the component “above other components or features” or “on other components or features” will include the case where the component is “below other components or features” or “under other components or features”. Thus, the exemplary term “above” can encompass both the orientations of “above” and “below”. In addition, these components or features may be otherwise oriented (for example rotated by 90 degrees or other angles) and the present disclosure is intended to include all these cases.

It should be noted that the terms used herein are only for describing specific embodiments, and are not intended to limit the exemplary embodiments according to the present application. As used herein, an expression of a singular form includes an expression of a plural form unless otherwise indicated. In addition, it should also be understood that when the terms “including” and/or “comprising” are used herein, it indicates the presence of features, steps, operations, parts, components and/or combinations thereof.

It should be noted that the terms “first”, “second” and the like in the description and claims, as well as the above accompanying drawings, of the present disclosure are used to distinguish similar objects, but not necessarily used to describe a specific order or precedence order. It should be understood that ordinal numbers used in this way can be interchanged as appropriate, so that the embodiments of the present disclosure described herein can be implemented in a sequence other than those illustrated or described herein.

What is claimed is:

1. A lead assembly comprising:
a plurality of conductive elements arranged along a longitudinal direction, each of the plurality of conductive elements comprising a mating contact portion, a mounting tail opposite the mating contact portion, and an intermediate portion joining the mating contact portion and the mounting tail, the mounting tail comprising:
a connecting portion extending from the intermediate portion,
a mounting end opposite the connecting portion, and
a main portion joining the connecting portion and the mounting end, wherein:
the mounting end has a diminishing longitudinal width in a mounting direction, and
the main portion is narrower than the connecting portion in the longitudinal direction.

2. The lead assembly of claim 1, wherein:
the main portion comprises a first subportion extending from the connecting portion and a second mounting subportion extending from the mounting end; and
the first subportion is wider than the second subportion portion in the longitudinal direction.

3. The lead assembly of claim 2, wherein:
the main portion comprises a transition subportion joining the first subportion and the second subportion; and
the transition subportion tapers from the first subportion to the second subportion in the longitudinal direction.

4. The lead assembly of claim 2, wherein:
the first subportion is longer than the second subportion in a vertical direction perpendicular to the longitudinal direction.

5. The lead assembly of claim 4, wherein:
the first subportion is at least twice as long as the second subportion.

6. The lead assembly of claim 2, wherein:
the second subportion has a longitudinal width between 0.17 mm and 0.23 mm.

7. The lead assembly of claim 2, wherein:
the first subportion has a longitudinal width between 0.22 mm to 0.28 mm.

8. The lead assembly of claim 1, wherein:
the mounting end has a length between 0.15 mm and 0.25 mm in a vertical direction perpendicular to the longitudinal direction.

9. The lead assembly of claim 1, wherein:
a tapered tip of the mounting end has a longitudinal width between 0.05 mm and 0.15 mm.

10. The lead assembly of claim 1, wherein:
the plurality of conductive elements comprise a plurality of first-type conductive elements and a plurality of second-type conductive elements alternately arranged along the longitudinal direction; and
the mounting end of the mounting tail of each of the plurality of second-type conductive elements is disposed farther from the mounting end of the mounting tail of a first adjacent first-type conductive element than the mounting end of the mounting tail of a second adjacent first-type conductive element.

11. The lead assembly of claim 10, wherein:
the connecting portion of the mounting tail of each of the plurality of first-type conductive elements extends from a first side of the intermediate portion of a respective conductive element;
the connecting portion of the mounting tail of each of the plurality of second-type conductive elements extends from a second side of the intermediate portion of a respective conductive element; and
for the intermediate portion of each of the plurality of conductive elements, the first side and the second side are opposite in the longitudinal direction.

12. The lead assembly of claim 10, wherein:
the connecting portion of each of the plurality of first-type conductive elements is bent, with respect to a respective intermediate portion, in a first transverse direction perpendicular to the longitudinal direction; and
the connecting portion of each of the plurality of second-type conductive elements is bent, with respect to a respective intermediate portion, in a second transverse direction opposite to the first transverse direction.

13. An electrical connector, comprising:
a housing comprising a mating surface having a slot extending in a longitudinal direction and a mounting surface opposite the mating surface;
a plurality of first-type conductive elements aligned in the longitudinal direction, each of the plurality of first-type conductive elements comprising a mating contact portion curving into the card slot and a mounting tail opposite the mating contact portion and extending beyond the mounting surface, the mounting tail having a mounting end; and
a plurality of second-type conductive elements, each of the plurality of second-type conductive elements comprising a mating contact portion curving into the card slot and a mounting tail opposite the mating contact portion and extending beyond the mounting surface, the mounting tail having a mounting end, wherein:
each of the plurality of second-type conductive elements is disposed between respective first and second adjacent first-type conductive elements; and
the mounting end of the mounting tail of each of the plurality of second-type conductive elements is disposed farther from the mounting end of the mounting tail of the respective first adjacent first-type conductive element than the mounting end of the mounting tail of the respective second adjacent first-type conductive element.

14. The electrical connector of claim 13, wherein:
each of the plurality of first-type conductive elements comprises an intermediate portion joining the mating contact portion and the mounting tail; and
for each of the plurality of first-type conductive elements:
the mounting tail comprises a connection portion extending from the intermediate portion and a main portion joining the connecting portion and the mounting end, and
the main portion is narrower than the connecting portion in the longitudinal direction.

15. The electrical connector of claim 14, wherein:
each of the plurality of second-type conductive elements comprises an intermediate portion joining the mating contact portion and the mounting tail; and
for each of the plurality of second-type conductive elements:
the mounting tail comprises a connection portion extending from the intermediate portion and a main portion joining the connecting portion and the mounting end, and
the main portion is narrower than the connecting portion.

16. The electrical connector of claim 14, wherein:
the main portion comprises a first subportion extending from the connecting portion and a second mounting subportion extending from the mounting end; and
the first subportion is wider than the second subportion in the longitudinal direction.

17. The electrical connector of claim 16, wherein:
the first subportion is longer than the second subportion in a vertical direction perpendicular to the longitudinal direction.

18. An electronic system comprising:
a printed circuit board comprising a plurality of pads and a plurality of through-holes, each of the plurality of through-holes passing through a respective pad of the plurality of pads and sized in the range of 0.35 mm to 0.45 mm; and
an electrical connector mounted on the printed circuit board, the electrical connector comprising:
a housing comprising a mating surface having a slot and a mounting surface opposite the mounting surface, and
a plurality of conductive elements, each of the plurality of conductive elements comprising a mating contact portion curving into the slot, a mounting tail extending beyond the mounting surface into a respective through-hole of the plurality of through-holes, the plurality of conductive elements configured to transfer data signals at rates in the range of 10 Gb/s to 150 Gb/s.

19. The electronic system of claim 18, wherein:
the plurality of conductive elements comprise a plurality of first-type conductive elements and a plurality of second-type conductive elements disposed alternatively; and
the mounting end of the mounting tail of each of the plurality of second-type conductive elements is disposed farther from the mounting end of the mounting tail of a first adjacent first-type conductive element than the mounting end of the mounting tail of a second adjacent first-type conductive element.

20. The electronic system of claim 19, wherein:
the plurality of through-holes comprise a plurality of first through-holes and a plurality of second through-holes; and
each of the plurality of second through-holes is disposed farther from a first adjacent first through-hole than a second adjacent first through-hole such that the plurality of first through-holes receive the plurality of first-type conductive elements and the plurality of second through-holes receive the plurality of second-type conductive elements.
